(19) United States
(12) Patent Application Publication
(10) Pub. No.: US 2022/0011004 A1
(43) Pub. Date: Jan. 13, 2022

(54) VERTICAL FAN COIL UNIT WITH PIPING AND VALVE ASSEMBLY HAVING LOSSLESS DYNAMIC PRESSURE

(71) Applicant: Vittorio BONOMI, Fort Lauderdale, FL (US)

(72) Inventor: Vittorio BONOMI, Fort Lauderdale, FL (US)

(21) Appl. No.: 17/447,005

(22) Filed: Sep. 7, 2021

Related U.S. Application Data
(63) Continuation-in-part of application No. 16/813,797, filed on Mar. 10, 2020, now Pat. No. 11,131,405.

(51) Int. Cl. F24F 11/84; F24F 1/0068; F24F 11/89

(52) U.S. Cl. CPC F24F 11/84; F24F 11/89; F24F 1/0068

(57) ABSTRACT

A vertical fan unit includes a cabinet, a fan unit and a heating and cooling coil. A piping and valve assembly connects the heating and cooling coil to a four-pipe vertical riser. Shut-off ball valves are connected to respective hot and cold supply pipes of the vertical riser out of the path of air flowing through the heating and cooling coil. Hot and cold return valve assemblies include control ball valves connected to respective return pipes of the four pipe vertical riser and positioned adjacent the side wall out of the path of air flowing through the heating and cooling coil. A cable connects each temperature probe of the shut-off ball valves with respective BTU meters mounted at the control ball valves.

### PRIORITY APPLICATION(S)

This is a continuation-in-part application based upon U.S. patent application Ser. No. 16/813,797, filed Mar. 10, 2020, the disclosure which is hereby incorporated by reference in its entirety.

### FIELD OF THE INVENTION

The present invention relates to vertical fan units, and more particularly, this invention relates to vertical fan units and associated piping and valve assemblies that include improved ball valves for lossless dynamic pressure.

### BACKGROUND OF THE INVENTION

Many heating, ventilation, and air conditioning (HVAC) systems use different piping packages that include pipes, valves, flexible hoses, and fittings that connect different distributed piping units in a building. These piping packages provide for the supply and return of hot water, chilled water, or refrigerant gas to HVAC coils and related HVAC components. Different HVAC components and systems are used depending on the HVAC system design, including convection heating systems, forced-air systems using various types of heat exchangers, and systems that employ HVAC air coils. Vertical fan units and similar HVAC designs are commonly used in many industrial, commercial and residential buildings and may include a heating and/or cooling heat exchanger, e.g., a “coil” and its associated fan. Other related HVAC systems use district cooling and heating, central heating and/or chilled water systems.

Different piping package designs may be installed by different manufacturers, such as in vertical fan units or other HVAC units. These systems sometimes operate as submeter applications that require a BTU meter to measure individual energy consumption and allows individual consumers to be billed for individual measured utility usage. Submeter applications often vary in design, with some systems having a two pipe, fan coil system with a single water coil connected to two pipes as a supply and return and one valve. Other systems have a four pipe, fan coil system with two separate cooling and heating water coils and dedicated supply and return pipes and valves. These systems include piping packages that are assembled with pipes, valves, flexible hoses, and fittings that connect terminal units of the distributed piping in a building and provide supply and return of hot water, chilled water, or refrigerant gas to HVAC coils, and depending on design, may be designed with or without metering devices. However, in many designs, metering devices are preferred, e.g., a BTU meter.

In piping assemblies that are configured for use with vertical fan units and similar HVAC units, there is usually some friction or head loss in the middle of the air duct because the different valves, meters, pipes, flexible hoses and fittings are positioned within the air path of either the air discharge, the air intake or both. The footprint of the HVAC unit and its components, for example, in a vertical fan unit, cannot be changed since the unit design does not permit these types of changes. There are also dimensional constraints for placement of the unit, making it difficult or impossible to change the footprint.

For example, a vertical fan unit may be dimensioned to fit within a particular location of a building, such as a specific corner of an apartment located within a high rise residential complex. In these close confines, it becomes difficult to service the valves and fittings, and difficult to maintain the different components, and even more difficult to replace some components after normal wear and tear because of the close confines of the system design. Because of the constraints in the system design, for example, in a vertical fan unit, there is usually some high friction, e.g., high head loss, as the air is blown or drawn over different components of the piping package. This creates inefficiency in the HVAC unit operation, increases energy consumption, raises costs of operation, and increases maintenance time and costs.

Manufacturers invest remarkable engineering works to design more compact or smaller system and/or component designs for the control and related valves, the fittings, the hoses, the meters, e.g., a BTU meter such as used in heating/cooling submeter applications, to facilitate inspection and maintenance. This is difficult in many systems design since the HVAC units have dedicated piping packages that are incorporated in the HVAC units. It is not possible to change unit dimensions and it would not be advantageous to avoid the pressure loss, also termed friction loss, due to the air resistance caused by so many components and parts making up the piping package that are located in the middle of the air duct. It is thus desirable to avoid the high pressure or head loss inside these different HVAC units, for example, a vertical fan unit, where the many components of a piping package interfere with the natural flow of air through the HVAC unit and its associated coil. Reducing the friction loss would reduce the load on the fan motor, which otherwise could be loaded to excess in order to move the same amount of air through the coil, thus increasing energy consumption and reducing the life of the motor.

Besides minimizing the number of valves, hoses, and meters that may interfere with the air flow, for example, in a vertical fan unit, some manufacturers have attempted to solve some of these issues by changing valves designs. For example, some ball valves have been designed to incorporate temperature sensors in an attempt to make the overall piping packages more compact and aid temperature sensing between supply and return lines in some HVAC systems.

The ball valves disclosed in both Chinese Patent No. 2466450 and U.S. Pat. No. 5,588,462 incorporate temperature sensors, but use straight through flow designs that are conventional, and still may increase overall size. Another example is the ball valve disclosed in Korean Patent No. KR101445269, which incorporates a temperature sensor and is angled to minimize space. It includes two fluid ports and allows the ball valve to be installed in a more narrow space than some conventional ball valves and associated components used in more conventional piping packages. This ball valve disclosed in the Korean '269 patent incorporates a manual handle located at the top of the valve. This configuration may be impractical for some vertical fan units and related designs, where the top handle to turn the valve off and on is impractical to reach.

That valve also includes a temperature probe, but its sensor may interfere with the ball valve rotation, because the ball requires a long cut as a circumferentially extending slot that covers a large segment of the outer surface of the ball. That type of design compromises the ball valve operation, makes assembly more difficult, and requires utmost care in its manual assembly. That design also does not lend itself to long-lasting performance and the slot design and placement of the temperature and gaskets compromise the life of the valve, and over time, gasket tears may occur, resulting in greater fluid leakage and fluid consumption. Once the gaskets are torn or damaged, the floating ball may be damaged or move out of axis. Overall, that type of ball valve may not withstand the higher pressures associated with some HVAC systems, increasing even more the possibility of gasket tears or that the “floating ball” will move and go out of axis.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

In general, a vertical fan unit for a heating, ventilation and cooling (HVAC) system may comprise a cabinet having front, rear and side walls defining an air duct, including a lower return air vent and upper supply air vent on a front of the cabinet and communicating with the air duct. A fan unit may be contained within the cabinet. A heating and cooling coil assembly may be contained within the air duct, wherein air is drawn by the fan unit through the lower return air vent, through the heating and cooling coil assembly, upward through the air duct, and discharged out of the upper supply air vent. A piping and valve assembly may connect the heating and cooling coil assembly to two coils with two pipes each, one coils for heating and one coil for cooling, total four pipes that includes hot and cold supply pipes and hot and cold return pipes to supply and return hot and cold water for heating and cooling from vertical risers. The piping and valve assembly may comprise hot and cold supply shut-off ball valves connected to respective hot and cold supply pipes of the four pipe from the vertical risers out of the path of air flow through the heating and cooling coil assembly within the air duct. Each hot and cold supply shut-off ball valve may comprise a ball valve mounted therein, an actuator mounted on the valve body and connected to said ball valve and configured to rotate the ball valve into open and closed positions, and a temperature probe mounted on the valve body opposite from said actuator and axially aligned therewith. Hot and cold return valve assemblies may be connected to respective hot and cold return pipes of the four pipe vertical riser and positioned adjacent the side wall out of the path of air flowing through the heating and cooling coil assembly within the air duct, and comprising respective hot and cold control ball valves connected to the heating and cooling coil assembly, respective electric actuators connected to each control ball valve, and a BTU meter mounted at each respective hot and cold control ball valve. A cable may connect each temperature probe of hot and cold supply shut-off ball valves with the respective BTU meter mounted at each respective hot and cold control ball valves.

Each hot and cold return valve assembly may further comprise an ultraviolet-C-band (UVC) LED source mounted on each electric actuator. Each hot and cold return valve assembly may include a hot and cold return check valve connected to respective hot and cold return pipes of the four pipe vertical riser. Each hot and cold return valve assembly may include an automatic balancing valve connected between each respective check valve and control ball valve connected thereto.

In an example, the four pipe vertical risers may be positioned at a rear of the cabinet, and said hot and cold supply pipes are adjacent to each other and said hot and cold return pipes are adjacent to each other. The return air vent may comprise a substantially rectangular opening on the front of the cabinet, and said heating and cooling coil assembly extends at an angle downward from the front to the rear wall at the return air vent. The heating and cooling coil assembly may comprise a heating coil and cooling coil juxtaposed to each other.

In yet another example, the piping and valve assembly may further comprise a flexible tube connecting a fluid port at each hot and cold supply shut-off ball valve with the heating and cooling coil assembly. Each supply shut-off ball valve may comprise an angle ball valve having a manual actuator, a first fluid port connected to a vertical riser pipe and a second fluid port connected to said heating and cooling coil assembly, said first and second fluid ports at about 90 degree orientation to the axial alignment of said actuator and temperature probe. The manual actuator of each supply shut-off ball valve may be accessible via an access opening of the cabinet. Each electric actuator may be substantially rectangular configured and each UVC LED source comprises first and second LED supports that engage adjacent sides of the respective electric actuator, and a bracket retaining the first and second LED supports on the electric actuator.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is an isometric view of the angle ball valve of a first embodiment.

FIG. 2 is an exploded isometric view of the angle ball valve of FIG. 1.

FIG. 3 is another exploded isometric view of the angle ball valve of FIG. 1.

FIG. 3A is an enlarged schematic, partial sectional view of a gasket supported within a sealing seat and the ball engaging the gasket.

FIG. 4 is an exploded isometric view of a portion of the valve body and ball for the angle ball valve of FIG. 1.

FIG. 5 is an exploded, vertical plan view of the angle ball valve of FIG. 1.

FIG. 6 is another exploded, plan view of the ball valve of FIG. 1.

FIG. 7 is a partial sectional view of the angle ball valve of FIG. 1.

FIG. 8 is another partial sectional view of the angle ball valve of FIG. 1.

FIG. 9 is an isometric view of a second embodiment of the angle ball valve that employs a manual handle as an isolation angle ball valve.

FIG. 10 is a sectional view of the angle ball valve of FIG. 9.

FIG. 11A is an isometric view of a third embodiment of the ball valve, but having a straight pass through configuration.

FIG. 11B is a sectional view of the ball valve of FIG. 11A taken along line 11B-11B.

FIG. 12 is an isometric view of a prior art vertical fan unit showing how the conventional valves and pipes are positioned to cause dynamic pressure loss.

FIG. 13 is a top plan view of the vertical fan unit of FIG. 12 and showing by a rectangular line the area of obstructed airstream and high dynamic pressure loss due to friction with the valves and piping.

FIG. 14 is an isometric view of a vertical fan unit that includes the piping and valve assembly configured for lossless dynamic pressure in the air duct.

FIG. 15 is a top plan view of the piping and valve assembly in the vertical fan unit of FIG. 14.

FIG. 16 is another isometric view of the vertical fan unit similar to that shown in FIG. 14 and showing air flow through the unit.

FIG. 17 is an enlarged isometric view of the piping and valve assembly shown in FIG. 14.

FIG. 18 is a side sectional view of the vertical fan unit shown in FIG. 14.

FIG. 19 is a bottom sectional plan view of the vertical fan unit shown in FIG. 14.

FIG. 20A is an enlarged isometric view of a return valve assembly showing the BTU meter and UVC LED source mounted on the electric actuator.

FIG. 20B is another enlarged isometric view of the return valve assembly shown in FIG. 20A.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

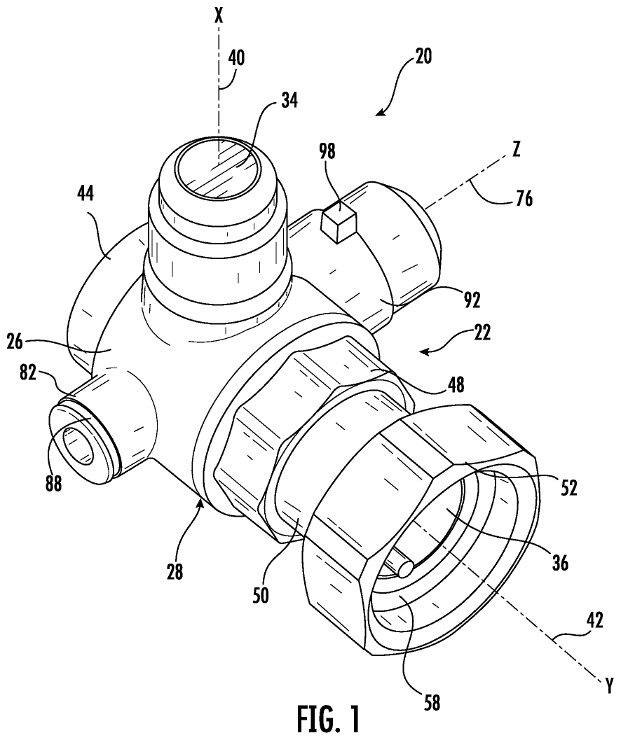

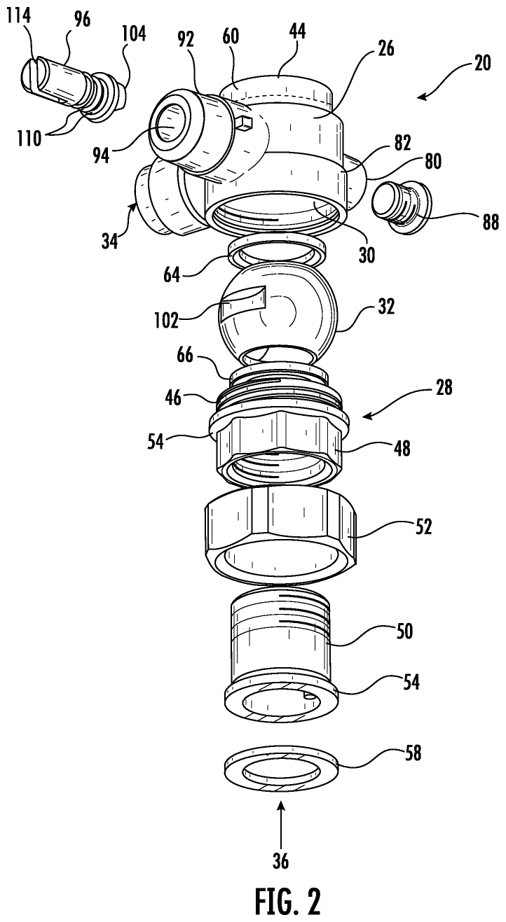

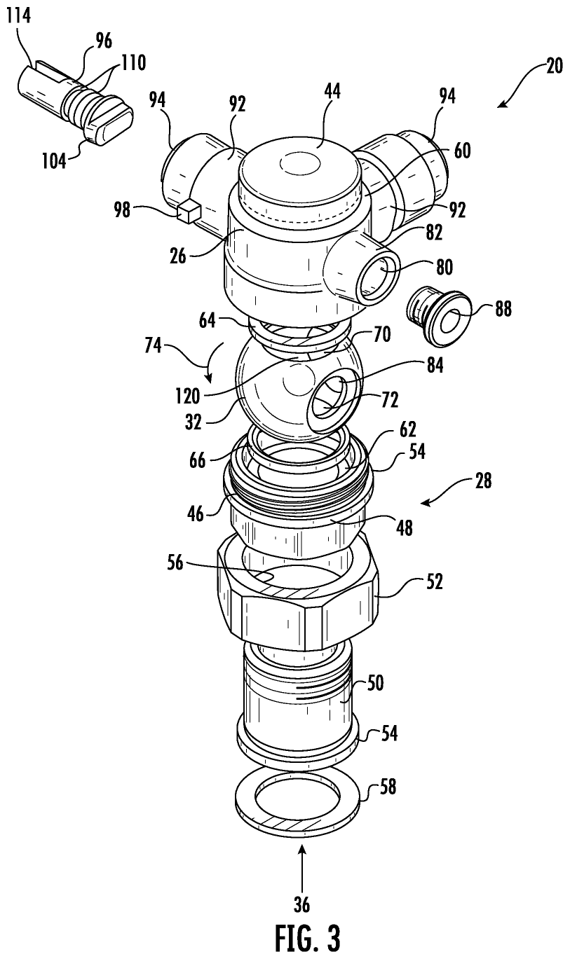

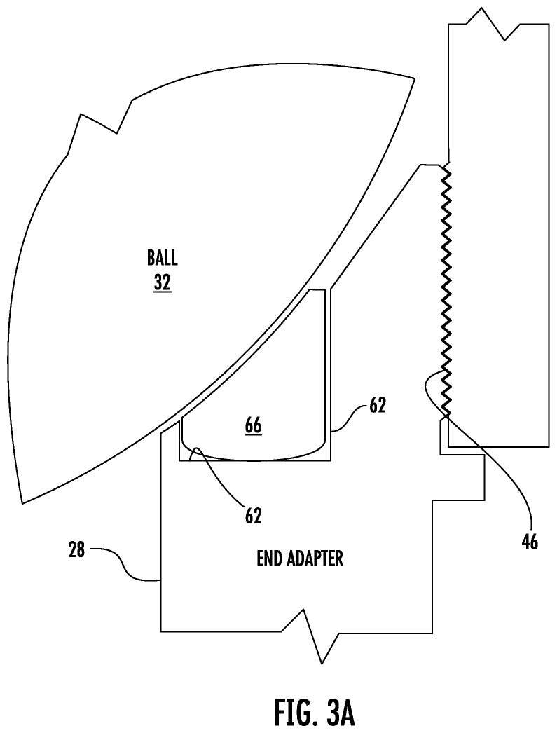

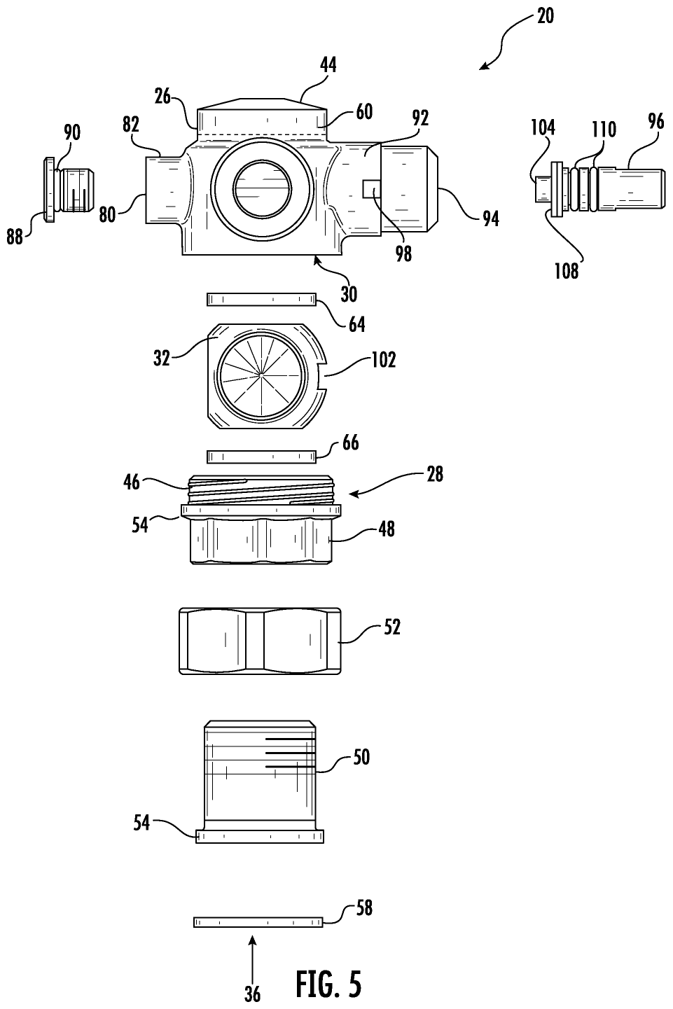

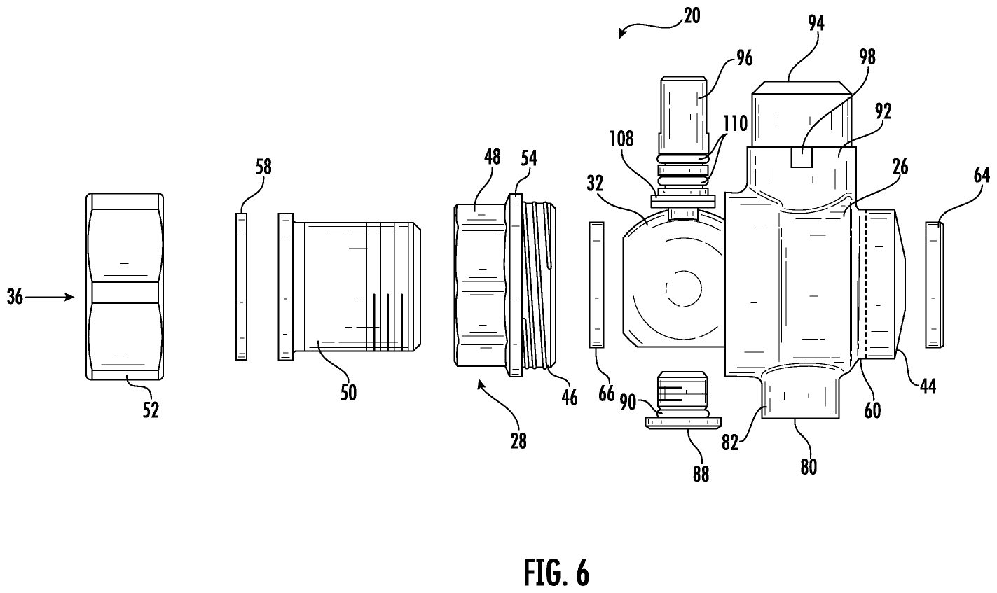

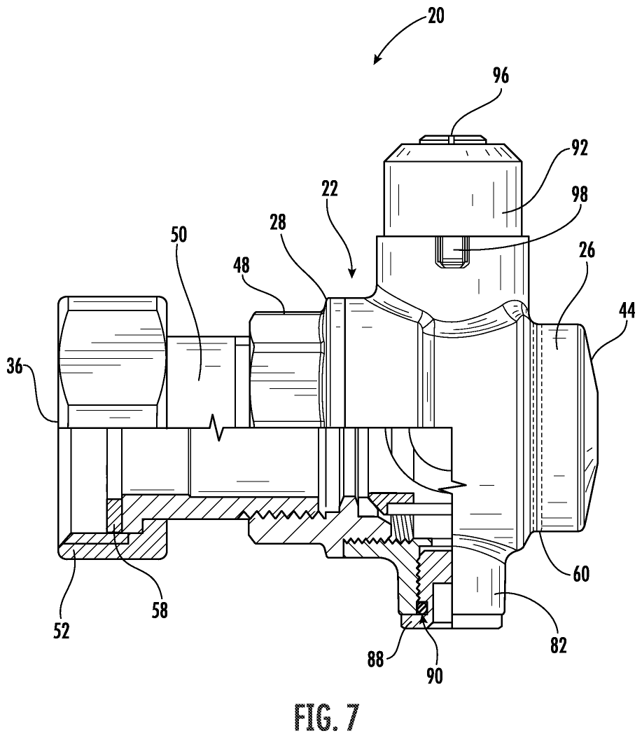

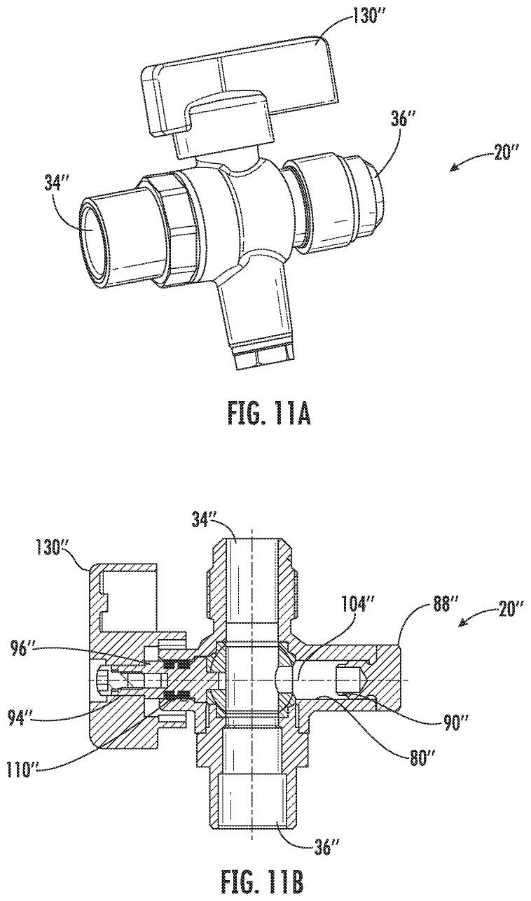

Referring now to FIGS. 1-8, there are illustrated different views of a first embodiment of the angle ball valve shown generally at 20, although the ball valve may be a straight configuration as shown in FIGS. 11A and 11B. The angle ball valve 20 in this example includes a valve housing 22 formed as a two-piece valve housing that includes a generally cylindrically configured valve body 26 and an end adapter 28 secured thereto and forming together a valve chamber 30 within the valve housing into which a valve is seated, which as explained below is formed as a hollow ball 32 (FIG. 2). A first fluid port 34 is formed within the valve housing 22 and communicates with the valve chamber 30, and a second fluid port 36 is formed within the end adapter 28 and defines a fluid path between the first and second fluid ports 34,36 through the valve chamber 30. In this example, the first and second fluid ports 34,36 are disposed substantially normal to each other and oriented along respective first and second longitudinal axes 40,42 indicated generally by the dashed lines in FIG. 1 forming a first transverse plane to the valve housing 22. The first and second fluid ports 34,36 are angled about 90° to each other along respective first and second longitudinal axis 40,42 that are transverse to each other. The valve body 26 has a closed end 44 opposite the second fluid port 36 as shown best in FIG. 3 and in the sectional view of FIG. 7. When installed in many HVAC systems, the angle ball valve 20 may be positioned such that the closed end 44 is the top section or side section relative to the HVAC unit, while the end adapter 28 and second fluid port 36 may be positioned as the lower or side section of the valve housing 22, as non-limiting examples.

In this example, the first fluid port 34 may be configured as an end fitting that may connect to a hose of a coil or isolation valve of a HVAC system or directly to a copper pipe. The second fluid port 36 may be configured on the end adapter as an end fitting to connect directly to a BTU meter in this example. The end adapter 28 may be configured to screw into the valve body 26 and includes a threaded male connector 46 and an outer perimeter section 48 configured to receive a wrench to tighten the end adapter into the valve body. As illustrated, a cylindrically configured joint member 50 is received within the end adapter 28 opposite the threaded male connector 46 such as by a press fit or via threads and into the end adapter. The joint member 50 receives a nut 52 over the cylindrical section or body forming the joint member, which includes a lower circumferential ridge 54 or shoulder extending outward that acts as a retainer and engages an internal lip or shoulder 56 formed on the nut to retain the nut on the joint member 50 when the joint member 50 is received and secured within the end adapter 28. The nut 52 has internal threads that may connect directly to a BTU meter and retain the BTU meter in a connection similar to a nut and tail end connection, so that the angle ball valve 20 can be connected to the BTU meter without the necessity of additional fittings and/or joint connection. A joint member gasket 58 or other sealing element may engage the outer perimeter section of the lower circumferential ridge 54 or shoulder and form a seal to a BTU meter.

In the embodiment shown in FIG. 1, the first and second fluid ports 34,36 are angled about 90° to each other along respective first and second longitudinal axes 40,42 that are substantially transverse to each other. As illustrated by the dashed lines in FIGS. 3, 5 and 6 and the sectional view of FIG. 7, a first annular configured sealing seat 60 is formed within the valve body 26 at end of the valve chamber 30 adjacent the closed end 44 and formed concentric to the second longitudinal axis 42 defined by the second fluid port 36. This first annular configured sealing seat 60 is configured similar to a second annular configured sealing seat 62 formed within the end adapter 28 adjacent the second fluid port 36 on the interior, annular section defined by the threaded male connector 46 and also concentric to the second longitudinal axis 42. These first and second annular configured sealing seats 60,62 form a valve seat for the hollow ball 32 that operates as the valve of the angle ball valve 20. A sealing element is positioned at each of the first and second annular configured sealing seats 60,62, and in this example, the sealing elements are formed as respective first and second gaskets, i.e., first and second respective gaskets 64,66 that are configured to fit within the respective first and second annular configured sealing seats 60,62. It should be understood that it is possible to use other sealing elements positioned at each annular configured sealing seat to form a seal for the hollow ball 32, which operate as a “floating” ball and configured to rotate on the gaskets 64,66 at the sealing seats 60,62 when positioned within the valve chamber 30 and in abutment to the gaskets 64,66, which with the sealing seats form a valve seat.

As illustrated, the hollow ball 32 is disposed within the valve chamber 30 at the valve seat and in abutment to the first and second gaskets 64,66. The hollow ball 32 has a spherical outer surface with planar cuts forming a first surface opening 70 and a second surface opening 72. The hollow ball 32 is mounted within the valve seat defined by the first and second gaskets 64,66 and is rotatable within the valve chamber 30 about an axis of ball rotation that is transverse to the first and second longitudinal axes 40,42 between open and closed ball valve positions. In the open ball valve position, the first surface opening 70 is aligned with the first fluid port 34 and the second surface opening 72 is aligned with the second fluid port 36 to allow fluid flow between first and second fluid ports through the hollow ball. In a closed ball valve position, fluid flow is prevented between the first and second fluid ports 34,36 because a closed surface section of the hollow ball that has no opening or other orifices blocks fluid flow into or out of one of the fluid ports, which in the example of FIG. 3, is shown to block the second fluid port 36 when the ball is rotated in the direction of the arrow shown at 74. In this example, the first and second fluid ports 34,36 are angled at about 90° to each other along respective first and second longitudinal axes 40,42 that are transverse to each other. The axis of ball rotation defines a third longitudinal axis 76 (FIG. 1) that is transverse to the first and second longitudinal axes 40,42, wherein the longitudinal axes define respective x, y and z axes for the angle ball valve 20.

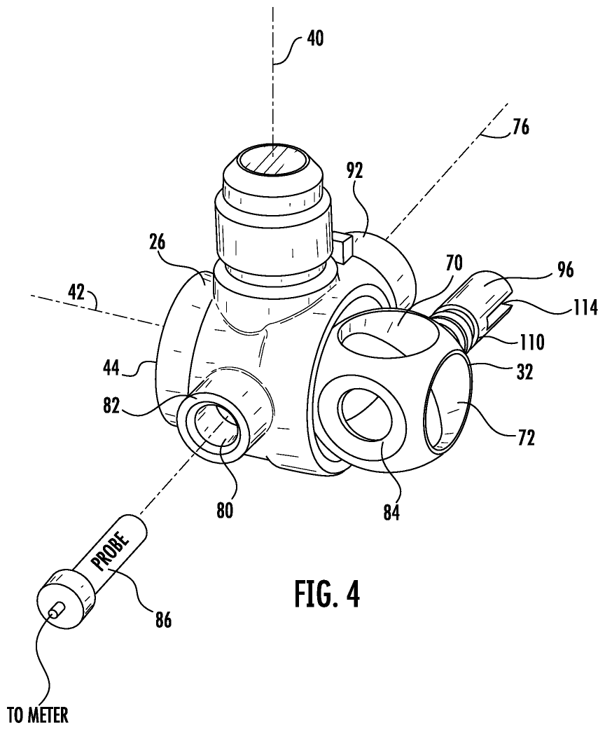

A first sensor orifice 80 is formed within the valve body 26 in axial alignment, the orifice being coaxial with the axis of ball rotation as defined by the third longitudinal axis 76. A cylindrical or barrel shaped support section 82 extends outward from the generally cylindrical configured valve body 26 and includes the first sensor orifice 80 as a bore extending therethrough. The diameter of this first sensor orifice 80 can be small enough to receive a sensor probe that may be only a few millimeters in diameter, depending on the size of the angle ball valve 20. The hollow ball 32 includes a second sensor orifice 84 into which the axis of a sensor or probe such as a temperature sensor extends into when the sensor is received in the first sensor orifice 80, and extends into the hollow ball 32 via the second sensor orifice to measure a physical parameter of the fluid flowing between first and second fluid ports 34,36 when the ball is rotated into an open ball valve position. In an example, the sensor is formed as a longitudinally extending probe shown at 86 in FIG. 4, e.g., a temperature sensor, that is of a sufficiently narrow diameter that it may be received into the second sensor orifice 84 of the hollow ball 32 for measuring the temperature of the fluid flowing through the ball between first and second fluid ports 34,36 when the ball is in the open valve position. The temperature probe 86 can be a small diameter probe made from a rigid material and a few millimeters or greater in diameter so that the second sensor orifice 84 formed in the hollow ball 32 is a small diameter also.

In the illustrated examples of FIGS. 2, 3, and 5-8, a sensor orifice plug or tap 88 as it is sometimes referred is inserted within the first sensor orifice 80 when the temperature probe or sensor is not used. This plug or tap 88 includes a gasket 90 to provide a seal to the first sensor orifice 80 and for the angle ball valve 20 when a temperature sensor 86 or other probe for sensing a physical parameter of the fluid is not used, and this prevents leakage of fluid out of the first sensor orifice 80. It should be understood that the fluid may be a gas or a liquid that can be measured and the angle ball valve 20 may operate with different gases or liquids for different HVAC and similar applications.

The temperature sensor 86 formed as a probe is received within the first sensor orifice 80 and extends through the second sensor orifice 84. On the opposite side of the valve body 26 from the first cylindrical support section 82 that includes the first sensor orifice 80 is yet another, but larger second cylindrical support section 92 that includes a stem orifice 94 formed within the valve body 26 opposite the first sensor orifice 80 and extending also along the axis of ball rotation that forms the third longitudinal axis 26, i.e., coaxial with that axis of ball rotation. A valve stem 96 is received within the stem orifice 94 and operatively connected to the ball 32. The valve stem 96 is rotatable to rotate the ball 32 into and out of open and closed ball valve positions. In this example, the first sensor orifice 80 and stem orifice 96 are positioned at opposite sides of the generally cylindrically configured valve housing 22, resulting in a side mounted valve stem and temperature probe as illustrated in FIG. 1 and subsequent figures. The second cylindrical support section 92 that receives the valve stem 96 includes tabs formed as mounting members 98 that may be configured to receive and have directly mounted thereon an electric actuator. The electric actuator may engage the valve stem 96 and controls rotation of the valve stem, and thus, controls rotation of the ball 32 between open and closed ball valve positions, which in one example is a 90° rotation.

As shown in FIGS. 2-6, the ball 32 includes its spherical outer surface and has an outer slit 102 formed therein, but not extending all the way through the spherical outer surface so that the slit does not communicate with the interior of the hollow ball 32. The valve stem 96 includes at its end that extends into the valve chamber 30 and engages the hollow ball 32, a rectangular configured projection 104 that engages the outer slit 102 so that when the valve stem 96 is turned, the valve stem rotates the ball along the axis of rotation defined by the third longitudinal axis 76. The valve stem 96 includes an annular abutment 108 at this end and positioned within the valve chamber 30 to engage the interior periphery of the stem orifice 94 on the inside surface of the valve body 26 defining the valve chamber 20 to prevent removal of the valve stem 96 outward from the valve body 21.

During assembly of this angle ball valve 20, before the end adapter 28, joint member 50 and nut 52 are assembled with the valve body 26, and before the ball 32 is inserted within the valve chamber 30, the valve stem 96 is configured in size such that it can be inserted into the valve body via the opening of the valve body 26 that the end adapter in an example threads into. The valve stem 96 is then inserted into the stem orifice 94 and pushed outward through the stem orifice such that the annular abutment 108 on the valve stem catches the interior of the valve chamber 30 at the periphery of the stem orifice to prevent the valve stem from passing outward from the valve body 26 and stem orifice 94. The valve stem 96 may include one or more pressure relief orifices in case pressure of the fluid flowing in the valve chamber 30 exceeds a predefined limit. The valve stem 96 may also include valve stem gaskets 110 or similar gaskets received within annular grooves. In this example, two valve stem gaskets 110 are received within two annular grooves that seal the valve stem and help reduce condensation from developing on any electric actuator 100 that may be connected to the valve stem 96 and mounted on the angle ball valve 20. This prevention of condensation from developing is beneficial since condensation could harm operation of the electric actuator 100. The valve stem 96 may include a sealing material that engages the ball and help rotation of the valve stem and ball rotation within the valve chamber 30. The rectangular projection 104 could be dovetail configured and the outer slit 102 could be dovetailed such that the ball is slid onto the dovetailed rectangular projection 104 when the ball is inserted into the valve chamber 30. The valve stem 96 before ball insertion is rotated within the valve chamber 30 into a proper orientation so that the ball may be inserted and the outer slit 102 receives the projection 104.

In a preferred example, each of the first and second gaskets 64,66 operate as the sealing gaskets for the ball 32 and are supported within first and second annular configured sealing seats 60,62. Each gasket 64,66 may be formed from polytetrafluoroethylene (PTFE), otherwise known by the tradename Teflon®, and the hollow ball 32 has a surface coated with PTFE. The gaskets 64,66 situated within the first and second annular configured sealing seats 60,62 are in abutment with the PTFE coated hollow ball 32. This material permits better sliding of the ball relative to the valve body 26 and the end adapter 28. It should be understood that other gasket materials may be used.

The ball 32 in this example is configured as shown in the exploded isometric and plan views of FIGS. 2-6 with cut, planar sections forming the first and second surface openings 70,72, and including the second sensor orifice 84, so that the ball 32 may rotate relatively easy on the first and second gaskets 64,66 without tearing of the gaskets and prolonging the sealing life of the gaskets. Although PTFE is a preferred gasket material and coating used for the ball 32, it should be understood that other materials can be used that reduce friction and provide an adequate sliding action between the ball and the gaskets 64,66. The gaskets 64,66 and the sealing seats 60,62 may be formed to have an angled configuration as shown diagrammatically in FIG. 3A, to maximize surface contact of the PTFE gaskets and the PTFE coated surface of the ball. Also, if there is a gasket failure, this type of angled configuration may reduce the amount of fluid leakage that may occur.

During installation, the valve stem 96 may be inserted and rotated so that the ball outer slit 102 may be slid relative to the rectangular projection 104 and engage the outer slit in the ball such that the ball slides into the valve chamber 30 on the projection. This step of installation can be accomplished manually or via automated assembly equipment. The first gasket 64 will usually be inserted onto the first annular configured sealing seat 60 before inserting the valve stem 96 and before inserting the ball 32. The second gasket 66 is inserted onto the second annular configured sealing seat 62 in the end adapter 28, which is then screwed into the valve body 26 after the ball 32, as a floating ball, had been inserted within the valve chamber 30 of the valve body 26 and positioned at the valve seat, i.e., in abutment with the first gasket 64. The joint member 50 may already have been inserted on the end adapter 28 and have the nut 52 thereon and be press fit into the opposing end of the end adapter or screwed therein. The nut 52 had been inserted over the joint member 50 before the joint member is secured within the end adapter 28. The nut 52 is retained by the lower circumferential ridge 54, or shoulder and internal shoulder or lip 56 that engage each other. The gasket 58 may be received over the joint member 50 or engage the lower edge in this example, and the BTU meter directly connected in an example.

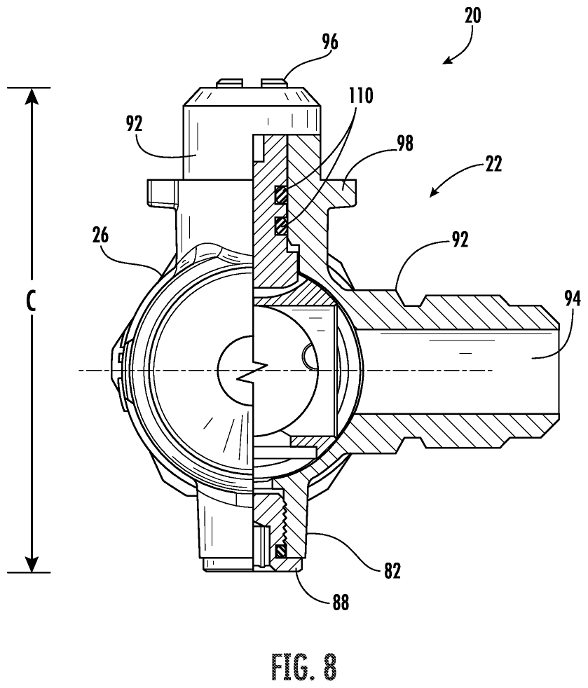

The angle ball valve 20 can be configured with different dimensions, but in one example, corresponds to a DN19 valve and the dimensions from the end of the stem orifice 94 to the other end of the angle ball valve 20 is about 70 millimeters as shown by dimension C in FIG. 8. Other dimensions of the angle ball valve 20 are relative to that overall dimension, and of course, dimensions can vary depending on end use applications. The valve stem 96 end opposite the rectangular projection 104 that engages the outer slit 102 may include a drive slot 114 to receive a driven section of an electric actuator 100 to drive or rotate the valve stem and, in turn, rotate the ball 32.

As illustrated, the ball 32 includes the first and second surface openings 70,72 that define fluid ports, but the ball may also be cut with a planar section to include another surface opening and form a third opening 120 as shown in FIG. 3, which may provide better rotation of the ball relative to the gaskets 64,66 and provide an additional opening so that a different rotation of the valve stem may rotate the ball into an open valve position. It should also be understood that the different components of the angle ball valve 20 may be made from different metallic and plastic materials, injection molded plastic or metal parts, or powdered or sintered metal.

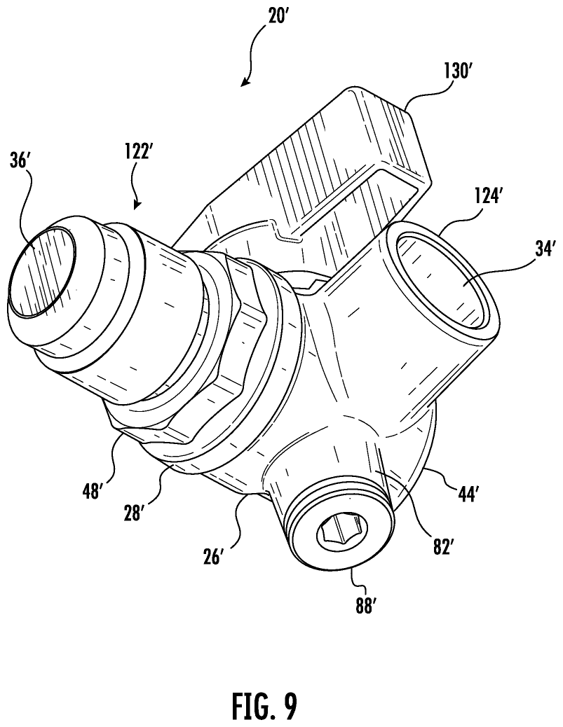

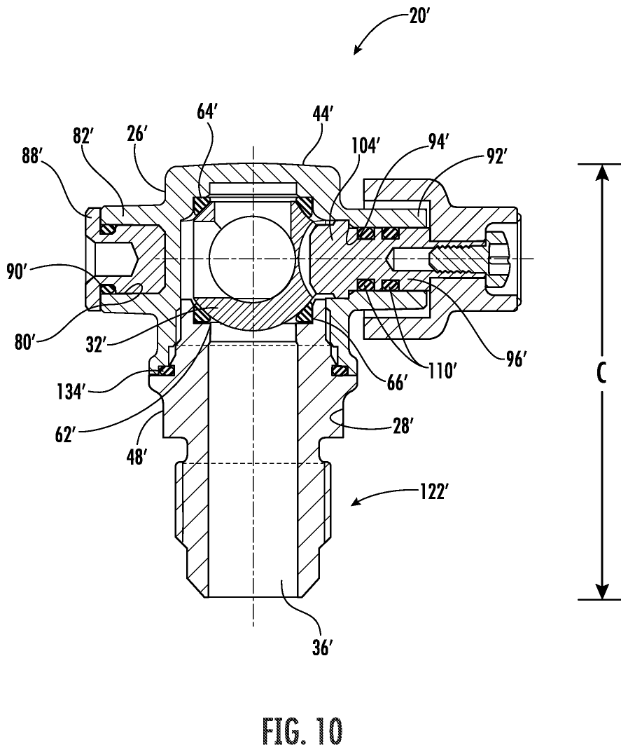

Referring now to FIGS. 9 and 10, there is illustrated a second embodiment of the angle ball valve 20′ that is configured as an isolation angle ball valve and with reference numbers given in prime notation. This isolation angle ball valve 20′ also includes the side mounted first sensor orifice 80′ and the opposing and side mounted stem orifice 94′, but with the valve stem 96′ connected to a manual handle illustrated generally at 130′. In the horizontal position shown in FIG. 9, the angle ball valve 20′ is in the closed ball valve position, and when the handle 130′ is turned vertically, the angle ball valve is in the open ball valve position, allowing fluid flow between the first and second fluid ports 34′,36′. The isolation angle ball valve 20′ includes a valve body 26′ and end adapter 28′, which also includes the second annular configured sealing seat 62′ and second gasket 66′. In this example of the isolation angle ball valve 20′, the end adapter 28′ is configured as a flared end connection 122′ that may connect to a flexible hose or pipe that extends to a control valve or a BTU meter as non-limiting examples. The inlet 124′ in this example isolation angle ball valve 20′ may connect to a building riser, such as the vertical copper risers often found in high rise residences or office complexes. The connection to the riser may be made using a sweat or FNPT end connection, which may include female internal threads as is typical for this type of connection.

The isolation angle ball valve 20′ in this example may be assembled using a similar assembly technique as with the angle ball valve 20′ of FIGS. 1-8. The valve body 26′ in the isolation angle ball valve 20′ may include the first annular configured sealing seat 60′ adjacent the closed end 44′, and a first gasket 64′ is inserted first onto the first annular configured sealing seat 60′. That step may be followed by the insertion of the valve stem 96′ and then insertion of the ball 32′, followed by screwing the end adapter 28′ having the second gasket 66′ into the valve body 26′. Once that step is accomplished, the ball 32′ floats on the valve seat formed by the gaskets 64′,66′, and in abutment with the first and second gaskets, and may be rotated into open and closed positions by turning the manual handle 130′ attached to the valve stem.

In the example of this manually operated isolation angle ball valve 20′ of FIGS. 9 and 10, a screw may be used to secure the handle 130′ into the valve stem 96′, which in this example is configured shorter than the valve stem in the first embodiment, but may still include two O-rings to provide a seal. The end adapter 28′ may also include a sealing ring 134′ that seals the end adapter once screwed into the valve body 26′. The end adapter 28′ in this second embodiment may be formed as a one piece unit, instead of having a separate joint member and nut as in the first embodiment. The total overall dimension shown by the dimension C in FIG. 10 could be about 62.5 millimeters with a DN11 size isolation angle ball valve 20′ with relative dimensions for the overall configuration. This is only one non-limiting example of dimensions and the isolation angle ball valve 20′ may be configured in different sizes and dimensions depending on end use application.

The two embodiments of the angle ball valve 20 and isolation angle ball valve 20′ may have different features with the embodiment shown in FIGS. 1-8 having a lubricant such as grease and being operative in temperature from −20° C. to about 100° C., while the embodiment of the isolation angle ball valve 20′ shown in FIGS. 9 and 10 may operate from −20° C. up to 150° C. and use a silicone lubricant, and have a stem rotation of about 90°.

A straight through configuration of the ball valve is shown in FIGS. 11A and 11B generally at 20″. Similar reference numerals as in previous figures are used, but with double prime notation. It also includes a sensor orifice 80″ and stem orifice 94″ and valve stem 96″ connected to a manual handle 130″. First and second fluid ports 34″, 36″ have a straight through linear configuration instead of the angled configuration. Other components are illustrated, but not described in detail.

A non-limiting example installation for a vertical fan unit as part of a HVAC system may include an isolation angle ball valve, which may be moved to the side of a vertical fan unit and positioned to the front so the valve handle, which is located not on top, but on the side, is easily accessible. The isolation angle ball valve may be positioned so that the manual valve handle faces the front and may be easily accessible when an access door is removed in order for a maintenance technician to access the interior of the vertical fan unit. The inlet of the ball valve such as corresponding to the first fluid port may connect to a building riser, e.g., vertical copper risers, such as Type M or Type L copper risers as non-limiting examples, using a sweat or FNPT end connection. The other flared end, in this example corresponding to the second fluid port may connect directly to a flexible hose that extends to a heating and cooling coil. The temperature sensor integrated in the ball valve may connect to a BTU meter and measure the temperature discrepancy between the supply and return. It is possible that the ball valve may be placed beside the coil of the fan unit so there is reduced air friction in the air duct when the air blows in the air duct, and in this example, over the coil. In an example, the electric actuator may be installed on the side of the coil to avoid obstruction resulting from high air friction or high head loss. A BTU meter display may be secured to the inside wall of the air duct to reduce friction and obstruction, and the BTU meter with a hydropic part may be connected to the ball valve 20 and installed in-line with a pipe in an example. A nut and tail end connection on the ball valve 20 may be provided as described relative to the embodiment in FIG. 1 to allow direct connection to the BTU meter.

Other examples and embodiments for the angle ball valve 20, including the isolation angle ball valve 20′ and straight configuration shown in FIGS. 11A and 11B, may be used in different engineering environments to solve problems that those skilled in the art will confront with different system installations. The ball valve 20, 20′, 20″ as described may be advantageously used with a manual valve handle or electric actuator, which is positioned on the side of the valve body and coaxial with the temperature sensor as a straight probe on the other side, such that the sensor will not interfere with the ball rotation. The design as described allows use of a ball hole or surface opening at the lower section of the ball corresponding in this example to adjacent the second fluid port 36, instead of having a cut and slotted section of the ball that extends around the outer surface or periphery of the ball such as in some prior art examples as in the Korean '269 patent. The angle ball valve 20 uses a second sensor orifice 84 that requires a smaller diameter orifice that is only slightly larger in diameter than the temperature sensor 86, which is received in the first sensor orifice 80. This configuration with the ball 32 and its openings 70,72 that cooperate with the fluid ports 34,36 together with the unique position of the annular configured sealing seats 60,62 and gaskets 64,66 reduces stress on gaskets and reduces the chances the ball will be driven out of alignment. There is no reduction in the angle ball valve operation and the reduced gasket or gasket wear reduces the chance of gasket tear or damage, which could increase fluid leakage. The assembly of this angle ball valve 20 is easier and can be automatically accomplished using automated machinery, as compared to some prior art designs that require careful, manual assembly. The ball 32 that is used as the floating ball and the different components, such as the valve body 26 and end adapter 28, may be produced from carbon steel, stainless steel, titanium and other metallic components, or from other materials such as nylon, carbon fiber, plastic, or other materials. Injection molded metallic or plastic materials can be used. Different electric actuators may be used with the angle ball valve.

As noted before, minor or dynamic losses in duct systems, such as part of a vertical fan unit, are pressure losses caused by such factors as a change in air direction from elbows, offsets and take-offs, or restrictions or obstructions in the airstream, including inlet and outlet fans, dampers, filters and coils. These loses may also occur from air velocity changes due to changes in duct sizes as the air is drawn or forced through ducts of varying size changes. The pressure loss may be created by the loss of total pressure in a duct or fitting, and there are observations that describe the benefits of using total pressure measurements for duct calculation and testing rather than using only static pressure measurements. The total pressure drops in ducts in the direction of flow, while static and dynamic pressures alone do not follow this rule.

The measurement of the energy level in an airstream may be represented by the total pressure, and the pressure losses in a duct may be represented by the combined potential and kinetic energy transformation as the loss of total pressure. Energy may increase both static and dynamic pressures, but the fan ratings in various vertical fan units may be based on static pressures, which may be partial. The pressure losses in duct work have three components, i.e., the frictional losses along duct walls, and dynamic losses, and fittings in the component losses in duct-mounted equipment. Dynamic pressure losses may be the result of changes in direction and in the velocity of air flow, and may occur when an airstream makes turns, diverges, converges, narrows, widens, enters, exits, or passes dampers, gates, orifices, coils, valves, filters, or sound attenuators.

Velocity profiles may be reorganized at different places by the development of vortexes that cause transformation of mechanical energy into heat. This disturbance of the velocity profile starts at some distance before the air reaches a fitting. The straightening of a flow stream may end some distance after the air passes the fitting. This distance may usually be assumed to be no shorter than about six duct diameters for a straight duct. Dynamic losses may be proportional to dynamic pressure and may be calculated using an equation where dynamic loss may be equal to the local loss coefficient as a factor of the dynamic pressure.

The local loss coefficient may also be known as the C-coefficient, which represents flow disturbances for particular fittings or duct-mounted equipment as a function of their type and ratio dimensions. Coefficients for such calculations may be found in the ASHRAE fittings diagrams. A local loss coefficient may be related to different velocities and the relevant part of velocity profiles is usually the highest velocity in the narrow part of a fitting cross-section or a straight/branch section in a junction. The frictional losses in duct sections may result from air viscosity and momentum exchange among particles moving with different velocities. These losses may contribute negligible losses or gains in air systems unless there are extremely long duct runs or there are significant sections using flex duct. It is possible to use a friction chart such as published by ASHRAE, 1997, to define frictional loss per unit length.

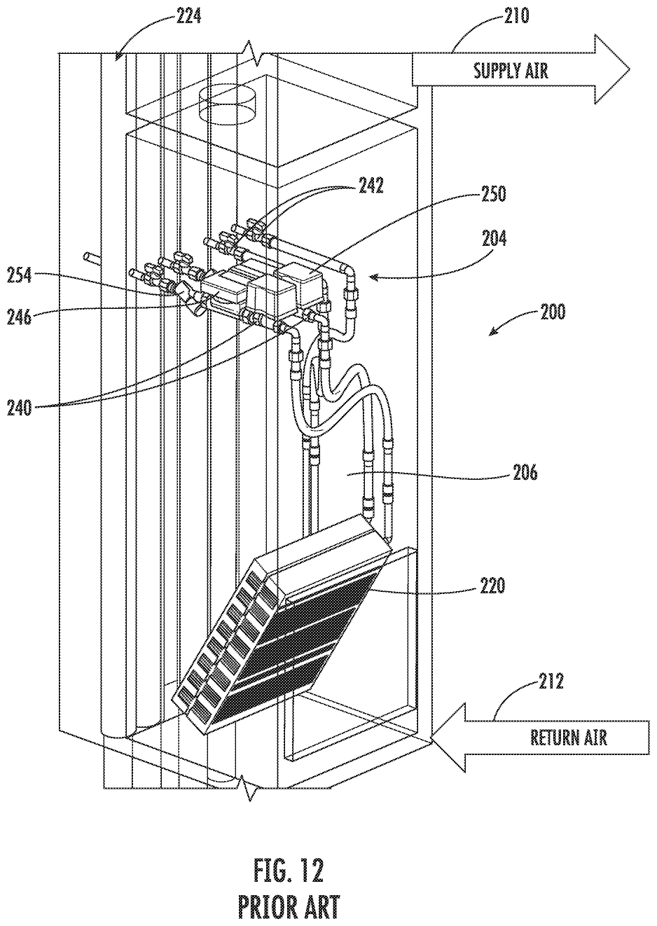

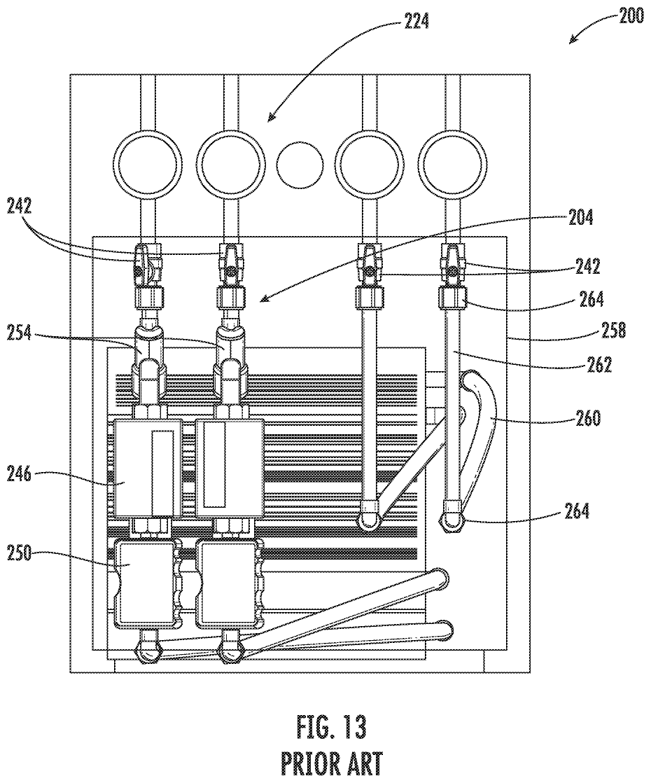

Referring now to FIGS. 12 and 13, there is illustrated generally at 200 a prior art vertical fan unit showing a conventional prior art piping and valve package 204 that obstructs the airstream flow within the illustrated air duct 206 of the vertical fan unit. The high dynamic pressure loss is due to friction of air within the vertical fan unit 200 impinging against the piping and valve package 204. The direction of supply air 210 and return air 212 are shown by the arrows where the return air passes over the heating and cooling coil assembly 220 and is forced upward in the air duct 206 and directly against the piping and valve package 204. The vertical fan unit 200 includes a four-pipe vertical riser 224. The heating and cooling coil assembly 220 includes separate cooling and heating water coils. The four-pipe vertical riser 224 includes dedicated cold and hot water supply and return pipes and associated control valves 240 and standard shut-off valves 242, and configured as straight pass through ball valves. The BTU meters 246 are illustrated. An electric actuator 250 is connected to each control valve 240. An automatic balancing valve 254 may be connected to each control valve 240. The top plan view looking down the air duct 206 in FIG. 13 shows by the rectangular line at 258 the area of obstructed airstream due to the piping valve package 204 and the high dynamic pressure loss due to friction with the piping valve package. The BTU meters 246, control valves 240, electric actuators 250, flexible hoses 260, rigid pipes 262, automatic balancing valves 254, and fittings 264 are primarily all located within the area of the air duct 206 that blocks air flow and creates high dynamic pressure losses. This air resistance is compounded by the fact that the shut-off valves 242 and control valves 240 are straight-line valves that cause the fittings 264 to extend even more into the air duct and create interference with the air flow. Use of straight-line shut-off valves 242 and control valves 240 is often standard in the industry and their use in vertical fan units.

The prior art piping and valve package 204 in the prior art examples of FIGS. 12 and 13 is located primarily inside the airstream, thus obstructing the airflow and interfering with the dynamic pressure and air flow velocity and increasing the minor dynamic loss coefficients. This creates the less efficient heating and cooling fan coil unit without an optimized energy efficiency ratio.

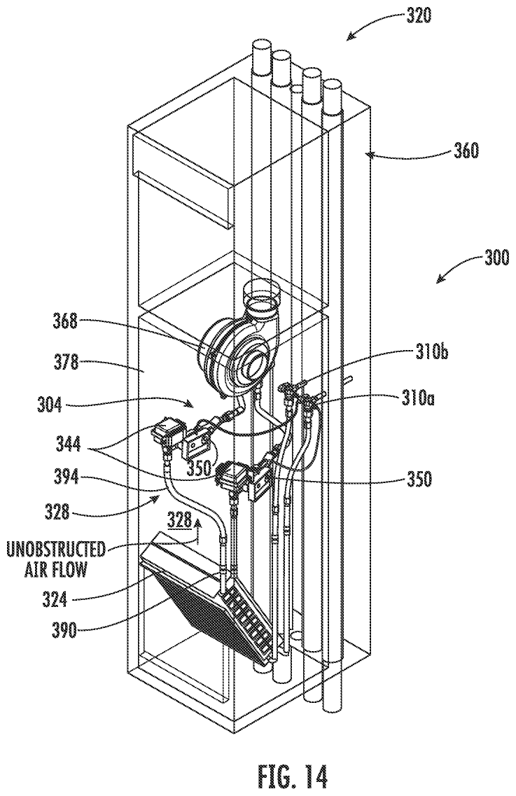

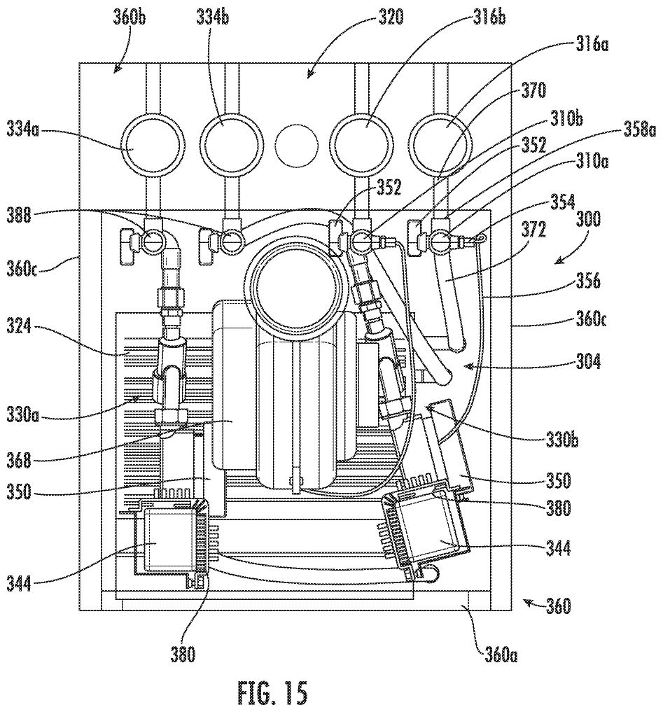

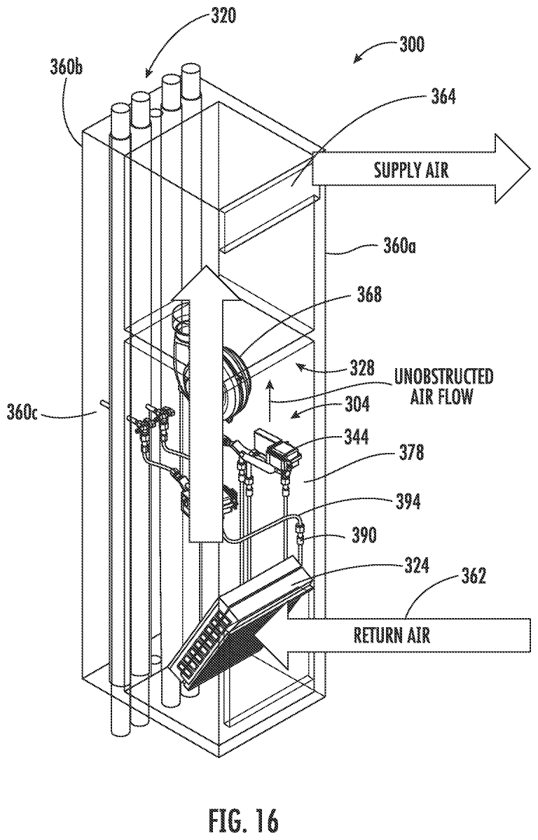

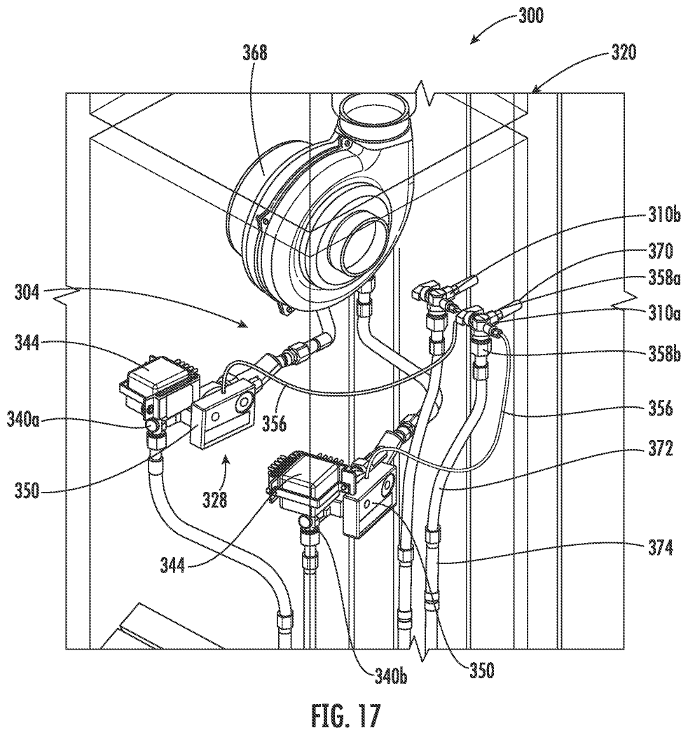

Referring now to FIGS. 14-20B, there are illustrated drawing views showing the vertical fan unit for a heating, ventilation, and cooling (HVAC) system indicated generally at 300, and includes a piping and valve assembly 304 having lossless dynamic pressure using the unique configuration with the ball valve such as described with reference to FIGS. 1-10 for use as hot and cold supply shut-off angle ball valves 310a, 310b (FIG. 15) that connect to respective hot and cold supply pipes 316a, 316b of the four-pipe vertical riser 320 adjacent to the illustrated riser and rear wall and out of the path of the air flow through the heating and cooling coil assembly 324 within the air duct 328 (FIGS. 14 and 16). Hot and cold return valve assemblies 330a, 330b (FIG. 15) are connected to respective hot and cold return pipes 334a, 334b of the four-pipe vertical riser 320 and positioned adjacent the side wall out of the path of air flowing through the heating and cooling coil assembly 324 within the air duct 328. They include the respective hot and cold control ball valves 340a, 340b (FIG. 17) connected to the heating and cooling coil assembly 324 with respective electric actuators 344 connected to each control ball valve 340a, 340b. A BTU meter 350 is mounted at each respective hot and cold control ball valve 340a, 340b. Because of the use of the angle ball valve as the hot and cold supply shut-off ball valves 310a, 310b that includes the manual actuator as a handle 352 in this example, and the temperature probe 354 mounted on the valve body opposite from the actuator as the handle and axially aligned therewith, this configuration allows the sensing cable 356 to connect each temperature probe of the hot and cold supply shut-off ball valve with the respective BTU meter 350 mounted at each of the respective hot and cold control ball valves 340a, 340b. This allows the BTU meter 350 to use the temperature port and temperature probe in the hot and cold supply shut-off ball valves instead of the temperature port of the BTU meter body. This configuration also saves space.

As illustrated in FIG. 16, the vertical fan unit 300 is formed as a cabinet 360 having front 360a, rear 360b, and side walls 360c defining the air duct 328. The cabinet 360 includes a lower return air vent 362 and an upper supply air vent 364 on the front 360a of the cabinet and communicating with the air duct 328. A fan unit 368 is contained within the cabinet 360 such as at a central portion of the cabinet near the upper section above the piping and valve assembly 304. The fan unit 368 may be designed such as a centrifugal fan unit.

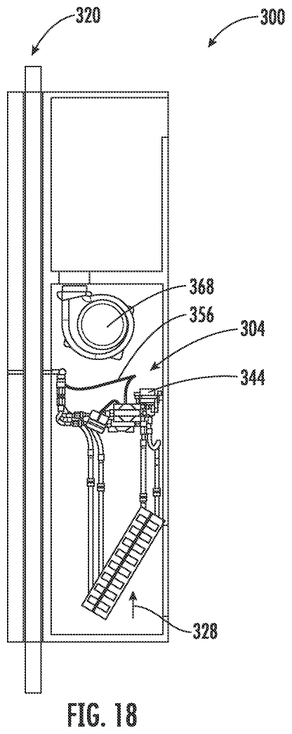

The heating and cooling coil assembly 324 is contained within the air duct 328. Air is drawn by the fan unit 364 through the lower return air vent 362, through the heating and cooling coil assembly 324, upward through the air duct 328, and discharged out of the upper supply air vent 364 as best shown in FIG. 16. As illustrated, the return air vent 362 includes a substantially rectangular opening on the front 360a of the cabinet 360 and the heating and cooling coil assembly 324 extends at an angle downward from the front to the rear wall 360b at the return air vent as also shown in FIG. 16 and in the side sectional view of FIG. 18.

The heating and cooling coil assembly 324 includes a heating coil and a cooling coil juxtaposed to each other and formed in a rectangular configuration such that the angle downward from the front wall 360a to the rear wall 360b at the return air vent 362 extends from the top section of the rectangular opening toward the rear at a level of the lower edge of the rectangular opening (FIG. 18). Air returning through that lower return air vent 362 must pass through the heating and cooling coil assembly 324 and both the heating coil and cooling coil that are juxtaposed to each other.

The piping and valve assembly 304 connects the heating and cooling coil assembly 324 to the four-pipe vertical riser 320 that includes the hot and cold supply pipes 316a, 316b and hot and cold return pipes 334a, 334b for heating and cooling. This piping and valve assembly 304 connects to the four-pipe vertical riser 320, which in the embodiment shown in FIGS. 14-19, is positioned at the rear wall 360b of the cabinet 360. The four-pipe vertical riser 320 includes hot and cold supply pipes 316a, 316b and hot and cold return pipes 334a, 334b for heating and cooling. The hot and cold supply pipes 316a, 316b are adjacent to each other and the hot and cold return pipes 334a, 334b are adjacent to each other. For example, the vertical riser 320 could extend upward in an apartment complex with a number of vertical fan units 300 positioned at each floor and each having the piping and valve assembly 304 that connect the respective heating and cooling coil assembly 324 in each vertical fan unit to the four-pipe vertical riser 320.

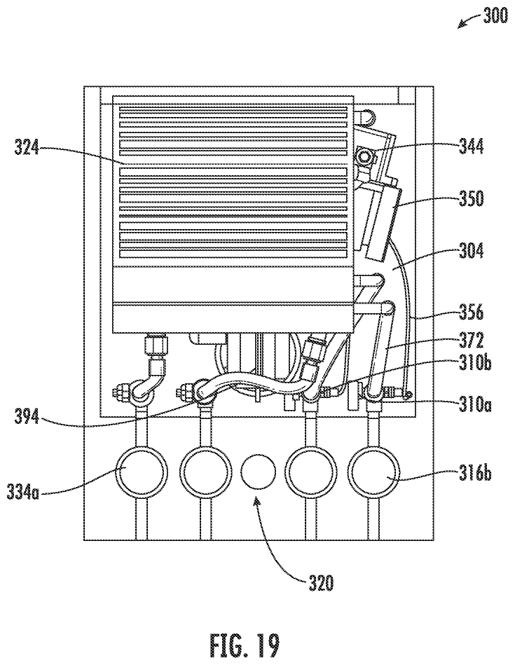

Hot and cold supply shut-off ball valves 310a, 310b are connected to the respective hot and cold supply pipes 316a, 316b of the four-pipe vertical riser 320 adjacent the rear wall 360b out of the path of air flow through the heating and cooling coil assembly 324 within the air duct 328. Each hot and cold supply shut-off ball valve 310a, 310b is preferably formed as an angled ball valve such as described relative to FIGS. 1-10 as shown in FIGS. 17 and 19.

As noted before with reference to the preceding FIGS. 1-10, each hot and cold supply shut-off ball valve 310a, 310b as an angled ball valve includes a ball valve mounted therein, an actuator such as the illustrated manual handle 352 mounted on the valve body and connected to the ball valve and configured to rotate the ball valve into open and closed positions. The temperature probe 354 is mounted on the valve body opposite from the actuator as the handle 352 and axially aligned therewith. A first fluid port 358a is connected to a vertical riser pipe such as through a conventional rigid connecting pipe 370 or sweat fitting and a second fluid port 358b is connected to the heating and cooling coil assembly 324 via a flexible hose 372 and straight pipe 374 connection (FIG. 18). The first and second fluid ports 358a, 358b are about 90° orientation to the axial alignment of the actuator as the manual handle 352 and temperature probe 354. The manual handle 352 of each supply shut-off ball valve is accessible via an access opening of the cabinet that may be formed in the area generally indicated at 378 as shown in FIGS. 14 and 16. The access opening 378 may be at the front wall 360a because of the unique design of the hot and cold shut-off angled ball valves 310a, 310b. A user may easily reach the handles 352 of the shut-off angled ball valves 310a, 310b and readily turn the handle off and on with little difficulty. In this example, the flexible hose 372 connects the first fluid port 358a at each hot and cold supply shut-off ball valve 310a, 310b with the heating and cooling coil assembly 324. The flexible tube 372 can be moved out of the way of the airflow as shown in the bottom plan view of FIG. 19 and connect to the rigid pipe 374 that connects into the heating and cooling coil assembly 324.

Each electric actuator 344 includes a mounted UVC LED source 380 that allows deep ultraviolet (UVC) LED (light emitting diode) light to provide coil sanitation, better IAQ rating, and reduce the total amount of bacteria and viruses. In an example, the LED's have an average wavelength output of about 265 nm (nanometers) with adequate germicidal efficacy ranging from 260 nm to 270 nm output as noted above.

The LED's 380 may be positioned on a flat printed circuit board plate and mounted on the outside surface of the electric actuator 344 and may be covered with a transparent cover and supported via a bracket 382. In an example, the viewing angle may be defined as twice the angle between the axial direction and the direction in which the light intensity value is half of the axial intensity. The intensity and surface area irradiated by a LED are all functions of the viewing angle.

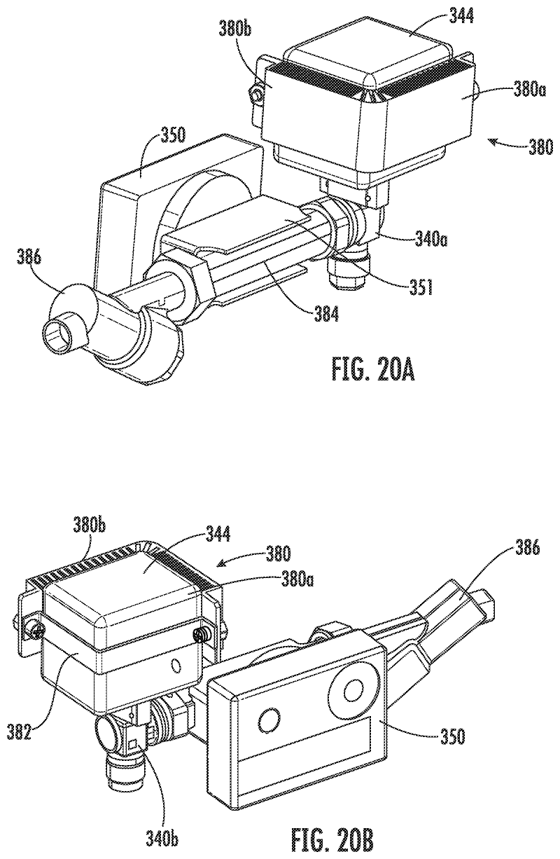

Hot and cold return valve assemblies are illustrated generally at 330a, 330b and connected to respective hot and cold return pipes 334a, 334b of the four-pipe vertical riser 320 and positioned adjacent to the side wall 360c out of the path of air flowing through the heating and cooling coil assembly 324 within the air duct 328. The hot and cold return valve assemblies 330a, 330b are formed as respective hot and cold control ball valves 340a, 340b connected to the heating and cooling coil assembly 324. In the illustrated embodiment, the hot and cold control ball valves 340a, 340b are formed as angle ball valves that permit respective electric actuators 344 to connect to each control ball valve as shown best and FIGS. 20A and 20B. A rigid pipe 384 extends from each control ball valve 340a, 340b in a horizontal orientation and connects into another valve as an automatic balancing valve 386 that is connected between a respective hot and cold return check valve 388 such as an angle ball valve and control ball valve 340a, 340b connected thereto (FIG. 15). The BTU meter 350 is mounted at each respective hot and cold control ball valve 340a, 340b such as by a clamp-on assembly 351 at the rigid pipe 384.

In accordance with a non-limiting embodiment, the temperature sensing cable 356 connects each temperature probe 354 of the hot and cold supply shut-off angle ball valve 310a, 310b with the respective BTU meter 350 mounted at each respective hot and cold control ball valve 340a, 340b. The hot and cold return check valves 388 are each connected to respective hot and cold return pipes 334a, 334b of the four-pipe vertical riser 320.

The hot and cold return valve assemblies 330a, 330b are positioned opposite to each other adjacent respective opposing side walls 360c as best shown in the top plan view of FIG. 15 where each are positioned out of the path of air flowing through the heating and cooling coil assembly 324 within the air duct 328. An ultraviolet C-band (UVC) LED (light emitting diode) source 380 is mounted on each electric actuator 344 and configured to direct the UVC light into the air duct 328 in an overlapping pattern to irradiate a substantial portion of the air duct within the cabinet. Other fittings 390 and arrangement of flexible pipes and tubes and rigid pipes 394 are arranged such that the components of the piping and valve assembly 304 are out of the air flow path in the air duct 328 as shown in FIGS. 14 and 16.

Referring again to FIGS. 20A and 20B, each electric actuator 344 is substantially rectangular configured and each UVC LED source 380 includes first and second LED supports 380a, 380b that are connected to each other in a right-angle configuration and engage adjacent sides of the respective electric actuator 344. The bracket 382 retains the first and second LED supports 380a, 380b on the electric actuator. The LED light source 380 generates heat, and for this reason, it is kept outside the actuator enclosure in a ventilated location and inside the air duct, but not enough to cause interference with the air flow. It is possible to have a wavelength of about 260-270 nanometers, but the range may extend from 240-280 nanometers depending on application and environment. There may be 50 watts power to reach 10 mJ/Cm² dose to kill many viruses within 30 seconds. It is possible to have one set of LED's operating at about 260 nm and another set of LED's that may operate at about 280 nm to obtain synergy. The LED source 380 may change angle during operation to have better coverage inside the vertical fan unit.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A vertical fan unit for a heating, ventilation and cooling (HVAC) system, comprising:
a cabinet having front, rear and side walls defining an air duct, including a lower return air vent and upper supply air vent on a front of the cabinet and communicating with the air duct;
a fan unit contained within the cabinet;
a heating and cooling coil assembly contained within the air duct, wherein air is drawn by the fan unit through the lower return air vent, through the heating and cooling coil assembly, upward through the air duct, and discharged out of the upper supply air vent; and
a piping and valve assembly connecting the heating and cooling coil assembly to a four pipe vertical riser that includes hot and cold supply pipes and hot and cold return pipes for heating and cooling, wherein said piping and valve assembly comprises,
hot and cold supply shut-off ball valves connected to respective hot and cold supply pipes of the four pipe vertical riser out of the path of air flow through the heating and cooling coil assembly within the air duct, each hot and cold supply shut-off ball valve comprising a ball valve mounted therein, an actuator mounted on the valve body and connected to said ball valve and configured to rotate the ball valve into open and closed positions, and a temperature probe mounted on the valve body opposite from said actuator and axially aligned therewith;
hot and cold return valve assemblies connected to respective hot and cold return pipes of the four pipe vertical riser and positioned adjacent the side wall out of the path of air flowing through the heating and cooling coil assembly within the air duct, and comprising respective hot and cold control ball valves connected to the heating and cooling coil assembly, respective electric actuators connected to each control ball valve, and a BTU meter mounted at each respective hot and cold control ball valve; and
a cable connecting each temperature probe of hot and cold supply shut-off ball valves with the respective BTU meter mounted at each respective hot and cold control ball valves.

2. The vertical fan unit of claim 1 wherein each hot and cold return valve assembly further comprises an ultraviolet-C-band (UVC) LED source mounted on each electric actuator.

3. The vertical fan unit of claim 1 wherein each hot and cold return valve assembly includes a hot and cold return check valve connected to respective hot and cold return pipes of the four pipe vertical riser.

4. The vertical fan unit of claim 3 wherein each hot and cold return valve assembly includes an automatic balancing valve connected between each respective check valve and control ball valve connected thereto.

5. The vertical fan unit of claim 1 wherein the four pipe vertical riser is positioned at a rear of the cabinet, and said hot and cold supply pipes are adjacent to each other and said hot and cold return pipes are adjacent to each other.

6. The vertical fan unit of claim 1 wherein the return air vent comprises a substantially rectangular opening on the front of the cabinet, and said heating and cooling coil assembly extends at an angle downward from the front to the rear wall at the return air vent.

7. The vertical fan unit of claim 1 wherein said heating and cooling coil assembly comprises a heating coil and cooling coil juxtaposed to each other.

8. The vertical fan unit of claim 1 wherein said piping and valve assembly further comprises a flexible tube connecting a fluid port at each hot and cold supply shut-off ball valve with the heating and cooling coil assembly.

9. The vertical fan unit of claim 1 wherein each supply shut-off ball valve comprises an angle ball valve having a manual actuator, a first fluid port connected to a vertical riser pipe and a second fluid port connected to said heating and cooling coil assembly, said first and second fluid ports at about 90 degree orientation to the axial alignment of said actuator and temperature probe.

10. The vertical fan unit of claim 9 wherein said manual actuator of each supply shut-off ball valve is accessible via an access opening of the cabinet.

11. A vertical fan unit for a heating, ventilation and cooling (HVAC) system, comprising:
a cabinet having front, rear and opposing side walls defining an air duct, including a lower return air vent and upper supply air vent on a front of the cabinet and communicating with the air duct;
a fan unit contained within the cabinet;
a heating and cooling coil assembly contained within the air duct adjacent the lower return air vent, wherein air is drawn by the fan unit through the lower return air vent, through the heating and cooling coil assembly, upward through the air duct, and discharged out of the upper supply air vent; and
a piping and valve assembly connecting the heating and cooling coil assembly to a four pipe vertical riser that includes hot and cold supply pipes and hot and cold return pipes for heating and cooling, wherein said piping and valve assembly comprises,
hot and cold supply shut-off ball valves connected to respective hot and cold supply pipes of the four pipe vertical riser out of the path of air flow through the heating and cooling coil assembly within the air duct, each hot and cold supply shut-off ball valve comprising a ball valve mounted therein, an actuator mounted on the valve body and connected to said ball valve and configured to rotate the ball valve into open and closed positions, wherein said actuator is accessible through an access opening of the cabinet, and a temperature probe mounted on the valve body opposite from said actuator and axially aligned therewith;
hot and cold return valve assemblies connected to respective hot and cold return pipes of the four pipe vertical riser and positioned opposite to each other adjacent respective opposing side walls, wherein each are positioned out of the path of air flowing through the heating and cooling coil assembly within the air duct, and comprising respective hot and cold control ball valves connected to the heating and cooling coil assembly, respective electric actuators connected to each control ball valve, and a BTU meter mounted at each respective hot and cold control ball valve;
a cable connecting each temperature probe of hot and cold supply shut-off ball valves with the respective BTU meter mounted at each respective hot and cold control ball valve; and
an ultraviolet-C-band (UVC) LED source mounted on each electric actuator and configured to direct the UVC light into the air duct in an overlapping pattern to irradiate a substantial portion of the air duct within the cabinet.

12. The vertical fan unit of claim 11 wherein each hot and cold return valve assembly includes a hot and cold return check valve connected to respective hot and cold return pipes of the four pipe vertical riser.

13. The vertical fan unit of claim 12 wherein each hot and cold return valve assembly includes an automatic balancing valve connected between each respective check valve and control ball valve connected thereto.

14. The vertical fan unit of claim 11 wherein the four pipe vertical riser is positioned at a rear of the cabinet, and said hot and cold supply pipes are adjacent to each other and said hot and cold return pipes are adjacent to each other.

15. The vertical fan unit of claim 11 wherein the return air vent comprises a substantially rectangular opening on the front of the cabinet, and said heating and cooling coil assembly extends at an angle downward from the front to the rear wall at the return air vent.

16. The vertical fan unit of claim 11 wherein said heating and cooling coil assembly comprises a heating coil and cooling coil juxtaposed to each other.

17. The vertical fan unit of claim 11 wherein said piping and valve assembly further comprises a flexible tube connecting a fluid port at each hot and cold supply shut-off ball valve with the heating and cooling coil assembly.

18. The vertical fan unit of claim 11 wherein each supply shut-off ball valve comprises an angle ball valve having a manual actuator, a first fluid port connected to a vertical riser pipe and a second fluid port connected to said heating and cooling coil assembly, said first and second fluid ports at about 90 degree orientation to the axial alignment of said actuator and temperature probe.

19. The vertical fan unit of claim 18 wherein said manual actuator of each supply shut-off ball valve is accessible via an access opening of the cabinet.

20. The vertical fan unit of claim 11 wherein each electric actuator is substantially rectangular configured and each UVC LED source comprises first and second LED supports that engage adjacent sides of the respective electric actuator, and a bracket retaining the first and second LED supports on the electric actuator.
